(19) United States
(12) Patent Application Publication
(10) Pub. No.: US 2006/0146995 A1
(43) Pub. Date: Jul. 6, 2006

(54) Method for providing phonemail service using wired and wireless communication

(76) Inventor: Kwang-Muk Kim, Seoul (KR)

Correspondence Address: CARSTENS & CAHOON, LLP, P O BOX 802334, DALLAS, TX, 75380, US

(21) Appl. No.: 11/152,874

(22) Filed: Jun. 15, 2005

(30) Foreign Application Priority Data
Dec. 20, 2004 (KR) 10-2004-0108912

(51) Int. Cl. H04M 11/00

(52) U.S. Cl. 379/88.14

(57) ABSTRACT

A method for providing a phonemail service using wired/wireless communication. A calling terminal constructs a phonemail message to be transmitted to a called terminal in the form of a plurality of link pages, such that a large amount of data to be transmitted from the calling terminal can be correctly transmitted to the called terminal. A user of the calling terminal can easily and quickly construct a phonemail message having a large amount of data using an exemplary phonemail message provided from a service provision system. Also, users of the calling and called terminals easily recognize meeting places, participants, and opinions of individual members using a variety of functions, e.g., location information, questionnaire information, and bulletin information.

### BACKGROUND OF THE INVENTION

1. Field of the Invention

The present invention relates to a method for providing a phonemail service, and more particularly to a method for providing a phonemail service using wired/wireless communication, which can allow a calling terminal to construct a phonemail message to be transmitted to a called terminal in the form of a plurality of link pages, can easily construct a phonemail message to be transmitted from the calling terminal using an exemplary phonemail message provided from a service provision system, and can allow each recipient to easily recognize meeting places, participants, and opinions of individual members using a variety of functions, e.g., location information, questionnaire information, and bulletin information.

2. Description of the Related Art

Recently, with the increasing development of information communication technologies, there has been widely used a network, such as the Internet, capable of allowing a user to communicate with a called party from anywhere the user wishes. Most users of the Internet gain access to the network using computers or wireless mobile communication terminals, and transmit a desired E-mail or phonemail message to a computer or wireless mobile communication terminal of a called party.

Current wireless mobile communication terminals, such as hand-held phones, have been designed to basically perform voice communication based on a wireless communication scheme and a Short Message Service (SMS) function capable of performing short text message communication.

However, the SMS service for use in the above-mentioned mobile communication terminal can transmit a short text message included in a single page to a called party, and aims to transmit a text message or a voice message to a called party. The size of one-shot data in the short text message included in the single page is relatively less than in an E-mail message for use in a general computer, such that the short text message is unable to correctly transmit caller information transmitted from an individual or company to a called party.

When a caller user transmits an E-mail message including general text messages, still images, avatars, and moving images to participants or members of clubs or meetings using a computer, the caller user must confirm whether individual participants or members have received the E-mail message, and must recognize opinions of individual participants or members of the clubs or meetings.

### SUMMARY OF THE INVENTION

Therefore, the present invention has been made in view of the above problems, and it is an object of the present invention to provide a method for allowing a calling terminal to construct a phonemail message to be transmitted to a called terminal in the form of a plurality of link pages.

It is another object of the present invention to provide a method for easily constructing a phonemail message to be transmitted from the calling terminal using an exemplary phonemail message provided from a service provision system.

It is yet another object of the present invention to provide a method for allowing each recipient to easily recognize meeting places, participants, and opinions of individual members using a variety of functions, e.g., location information, questionnaire information, and bulletin information provided from a plurality of link pages.

In accordance with the present invention, the above and other objects can be accomplished by the provision of a method for providing a phonemail service using wired/wireless communication, comprising the steps of: a) receiving, by a service provision system, personal information from a user of the calling terminal, registering the user as a member in the service provision system, and receiving log-in information from the user of the calling terminal; b) constructing, by the service provision system, a new phonemail message including at least one of location, questionnaire, and bulletin menus using a page edition database (DB) upon receiving a request from the calling terminal, or editing content of an exemplary phonemail message to be transmitted from among a plurality of exemplary phonemail messages pre-stored in a basic mail DB; c) if the new phonemail message is composed or the exemplary phonemail message is edited at step b) such that the calling terminal selects a preview function for the composed or edited phonemail message, determining, by the service provision system, whether the composed or edited phonemail message is correctly constructed; d) if it is determined that the composed or edited phonemail message is correctly constructed at step c), receiving, by the service provision system, a phone number of a called terminal and an operation signal of a mail transmission button from the user of the calling terminal; and e) confirming, by a user of the called terminal, a phonemail message transmitted via the service provision system, and receiving, by the service provision system, response signals corresponding to questionnaire and bulletin menus from the called terminal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a system applied to a method for providing a phonemail service using wired/wireless communication in accordance with the present invention;

FIG. 2 is a flow chart illustrating a method for providing a phonemail service using wired/wireless communication in accordance with the present invention;

FIG. 3 is an exemplary membership registration screen image for allowing a user to register himself or herself as a member in a service provision system in accordance with the present invention;

FIG. 4 is an exemplary screen image for inviting a user to edit a phonemail subpage in accordance with the present invention;

FIG. 5 is an example for inviting a user to edit a phonemail subpage in accordance with the present invention;

FIG. 6 is an exemplary screen image for inviting a user to enter detailed content of a phonemail subpage in accordance with the present invention;

FIG. 7 is an exemplary screen image illustrating the edition of a phonemail subpage in accordance with the present invention;

FIG. 8 is an exemplary screen image illustrating the edition of a plurality of link pages included in a phonemail message in accordance with the present invention;

FIG. 9 shows exemplary phonemail messages displayed on a called terminal using a phonemail service provision method based on wired/wireless communication in accordance with the present invention; and

FIG. 10 shows representative phonemail messages in accordance with the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

Typically, in order to transmit E-mail or phonemail messages, a relationship of a calling terminal to a called terminal may be determined to be one of a variety of relationships, for example, a relationship of a computer to a computer, a relationship of a computer to a mobile communication terminal, a relationship of a mobile communication terminal to a computer, a relationship of a mobile communication terminal to a mobile communication terminal. Particularly, provided that the called terminal is a computer, most users transmit or receive E-mail messages using a mail server. Therefore, the following description will hereinafter disclose only a specific case in which the called terminal is a mobile communication terminal.

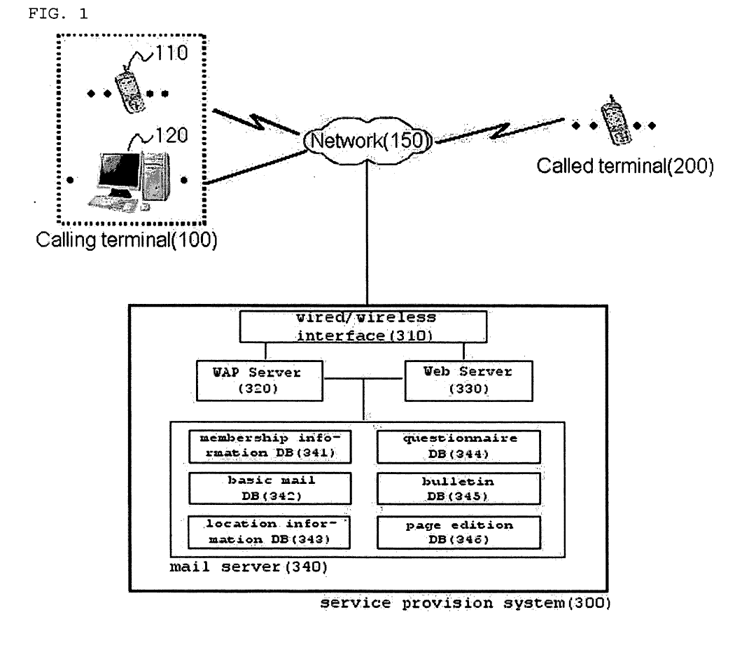

FIG. 1 is a block diagram illustrating a system applied to a method for providing a phonemail service using wired/wireless communication in accordance with the present invention.

Referring to FIG. 1, a system for use in a phonemail service provision method using wired/wireless communication includes a calling terminal 100, a network 150, a called terminal 200, and a service provision system 300.

The calling terminal 100 gains access to the service provision system 300, and edits a phonemail message to be transmitted to a called terminal 200 in the form of a plurality of link pages. The calling terminal 100 searches for an exemplary phonemail message, which has already been edited and stored, selects and edits the exemplary phonemail message, transmits the edited phonemail message to the called terminal 200, and includes a mobile communication terminal 110 and a computer 120.

In this case, the mobile communication terminal 110 is indicative of a Personal Digital Assistant (PDA), a mobile phone, or an IMT-2000 phone, which can perform wireless Internet communication. The computer 120 may be a personal computer capable of transmitting associated information to members who register in clubs or meeting, and may be a commercial-grade computer, such as a server, capable of allowing companies to commercially transmit phonemail messages to members to achieve various ends such as advertisement or marketing.

The computer 120 is indicative of a communicable computer device, includes an Internet browser capable of displaying Web-content, and is a desktop computer, or a notebook computer, etc. Preferably, the computer 120 may include at least Windows98 Operating System (OS), a Pentium-class CPU, more than 64 Mb memory, a scanner, a digital camera, and a data entry unit such as a mouse or keyboard.

A network 150 employs wireless Internet network protocols, for example, a TCP/IP for enabling a wired access function, and a Wireless Application Protocol (WAP) for enabling a wireless access function.

The called terminal 200 receives a callback SMS phonemail message from the calling terminal 100 via the service provision system 300, gains access to the service provision system 300, confirms the received phonemail message, and at the same time constructs corresponding content associated with questionnaire information or bulletin information.

The service provision system 300 can allow a user of the calling terminal 100 to construct a phonemail message to be transmitted in the form of a plurality of link pages, and includes a wired/wireless interface 310, a WAP server 320, a Web server 330, and a mail server 340. Although there is no illustration in FIG. 1, the service provision system 300 can conduct a large number of tasks associated with the present invention, can perform a large number of mathematical calculations when performing data communication between the calling terminal 100 and the called terminal 200, and at the same time examines a database (DB). The service provision system 300 includes a CPU operated by an additional OS, a storage unit acting as a more than 1 Gb memory to temporarily store data associated with the present invention, and a data entry unit such as a mouse or keyboard, and a data output unit such as a monitor.

In this case, the service provision system 300 may be provided to a mobile communication service enterprise, or may be an additional operating system having already been associated with the mobile communication service enterprise.

The wired/wireless interface 310 can allow the calling terminal 100 to communicate with the called terminal 200 by wire or wirelessly.

The WAP server 320 and the Web server 330 respond to request signals of the calling terminal 100 and the called terminal 200 by wire or wirelessly.

The mail server 340 is indicative of a server capable of providing a phonemail message associated with the present invention. The mail server 340 includes a membership information DB 341, a basic mail DB 342, a location information DB 343, a questionnaire DB 344, a bulletin DB 345, and a page edition DB 346.

In this case, the membership information DB 341 manages a variety of information of a user, registered as a member in the service provision system 300 using the calling terminal 100, for example, ID, name, resident registration number, password, mobile phone number, and E-mail address of the user, etc.

The basic mail DB 342 stores a tool for constructing a variety of messages (e.g., text-, emoticon-, music-, and video messages) generally used by a user of the calling terminal 100 during a phonemail composition mode, and basic exemplary phonemail messages, such that the user of the calling terminal 100 can easily use the tool and the basic exemplary phonemail messages.

The location information DB 343 can invite users of the calling terminal 100 and the called terminal 200 to mutually agree to visually indicate their location information, and includes map and geographical information.

In more detail, the location information DB 343 controls map and location information to be exposed to a phonemail to be transmitted from the calling terminal 100 to a plurality of called terminals 200, such that people who participate in engagements, invitations, and various meetings can easily meet each other, and allows a variety of companies to inform individual members of their location information.

In the case where the questionnaire DB 344 receives a predetermined keyword from the calling terminal 100, member users of a plurality of called terminals 200 gain access to the service provision system 300 using their phone number, and respond to an output signal of the service provision system 300, the questionnaire DB 344 collects the response results in real time, and transmits the collected response results to individual members.

The bulletin DB 345 receives a predetermined keyword from the calling terminal 100, member users of a plurality of called terminals 200 gain access to the service provision system 300 using phone numbers of their mobile communication terminals, provide opinions associated with the keyword in real time, and can allow one user to view opinions of other member users in real time.

In more detail, if the calling terminal 100 transmits a phonemail message to the called terminal 200 via the service provision system 300, the questionnaire DB 344 and the bulletin DB 345 can invite each member who views the phonemail message to recognize response results and opinions of other members in real time, instead of constructing a general phonemail message whose content is only transmitted to the called terminal 200 without any change.

The page edition DB 346 can allow a user of the calling terminal 100 to construct a phonemail message to be transmitted to the called terminal 200 in the form of a plurality of link pages. The phonemail message edited in the form of a plurality of link pages by the page edition DB 346 is stored in the basic mail DB 342, such that it can be used as an exemplary phonemail message.

The page edition DB 346 can add or delete a single main page and a subpage of the main page, and can construct a tree-structured phonemail message configured in the form of a plurality of link pages.

A method for providing a phonemail message using wired/wireless communication in accordance with a preferred embodiment of the present invention will hereinafter be described with reference to FIGS. 1˜9.

A user of the calling terminal 100 constructs a new phonemail message, and transmits the new phonemail message to a plurality of called terminals held by members or customers, and can allow the called terminals to confirm the transmitted phonemail message. There are two phonemail transmission methods, and a detailed description thereof will hereinafter be described in detail.

A first phonemail transmission method (hereinafter referred to as a first method) allows a user of the calling terminal 100 to construct and transmit a new phonemail message having a plurality of pages. A second phonemail transmission method (hereinafter referred to as a second method) stores the new phonemail message constructed by a user or administrator of the calling terminal 100, and uses the stored phonemail message as an exemplary phonemail message.

In this case, an exemplary phonemail message constructed by the above-mentioned second method is used after the new phonemail message constructed by the user or administrator of the first method is stored in the service provision system 300, such that a method for constructing/transmitting such a new phonemail message using the first method, and a method for confirming the transmitted phonemail message will hereinafter be described in detail.

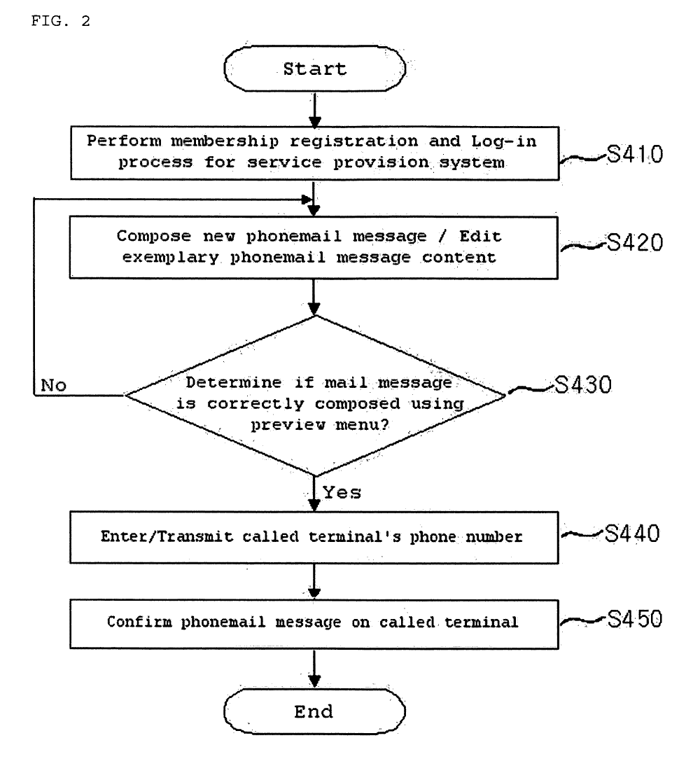

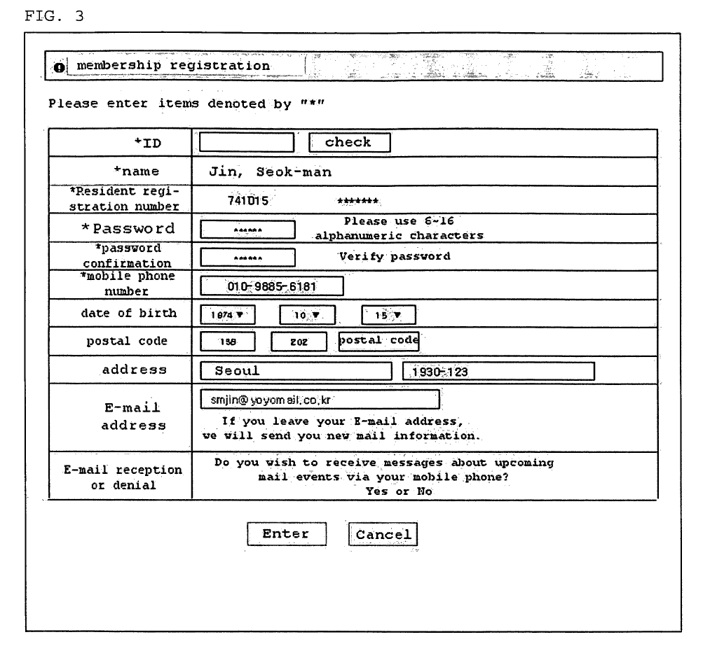

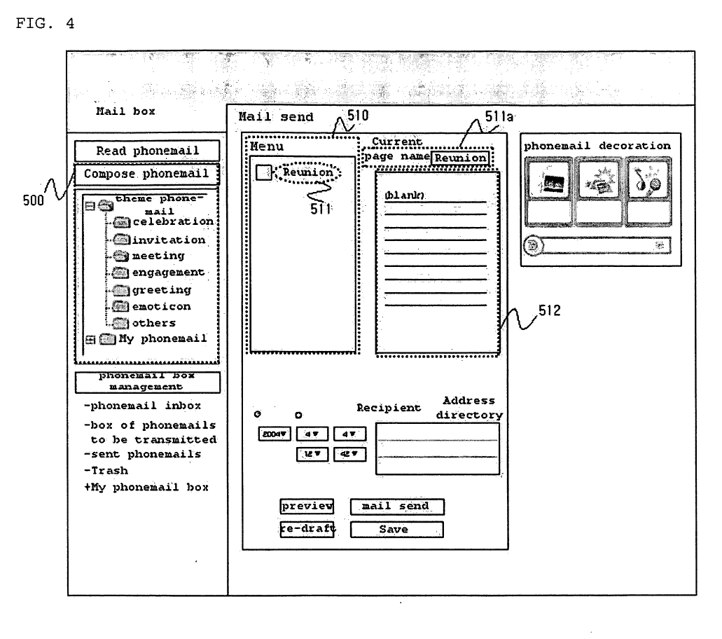

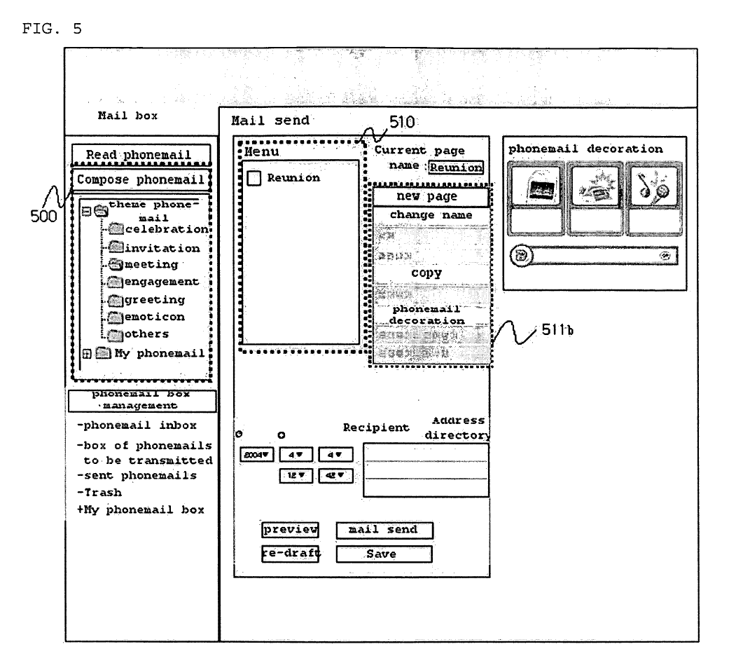

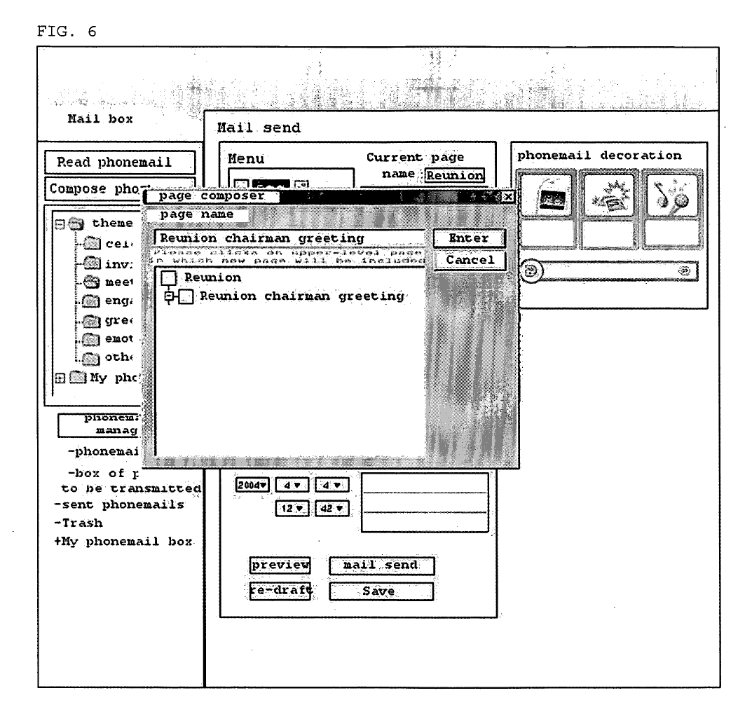

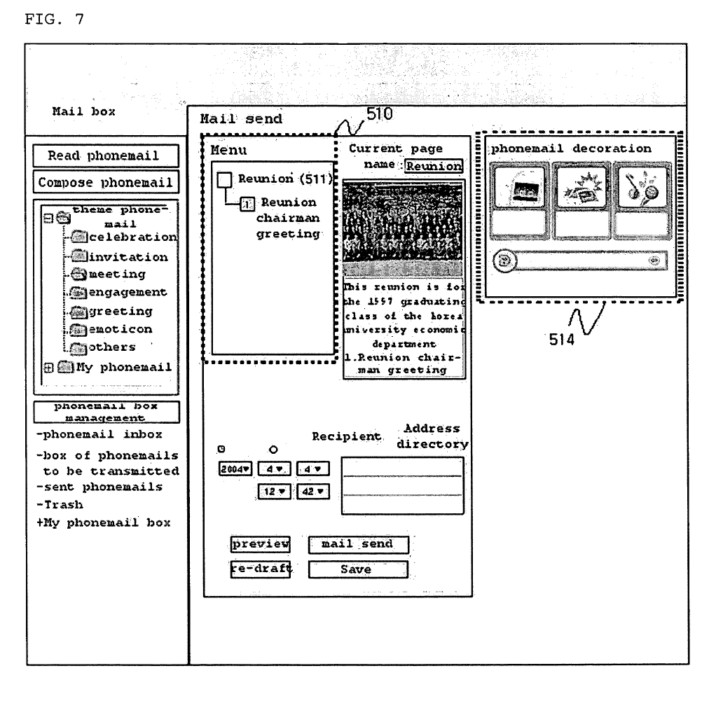

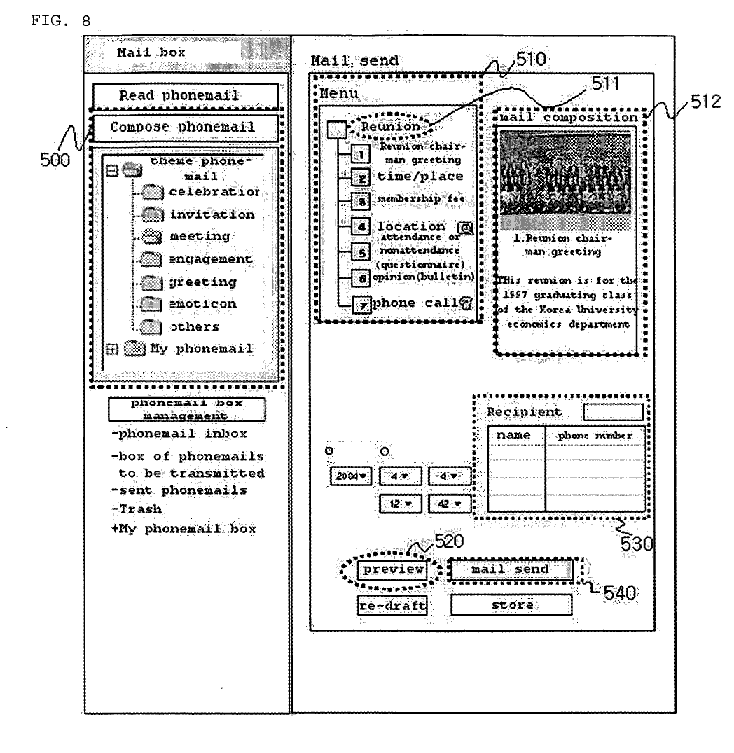

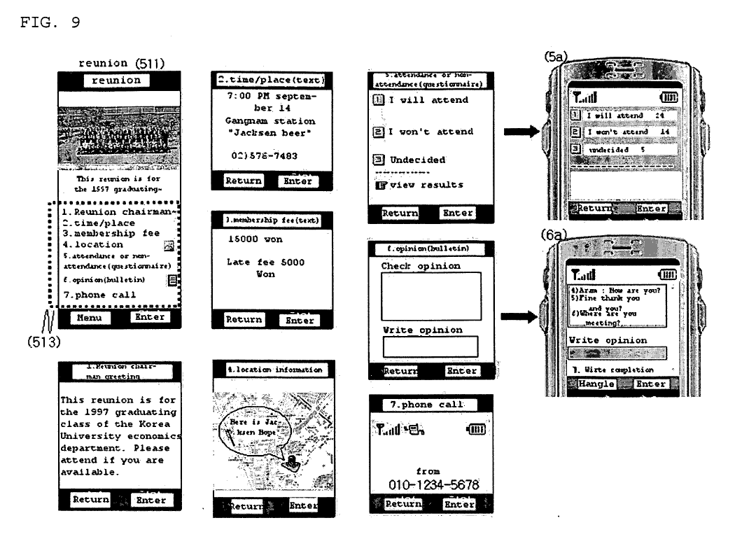

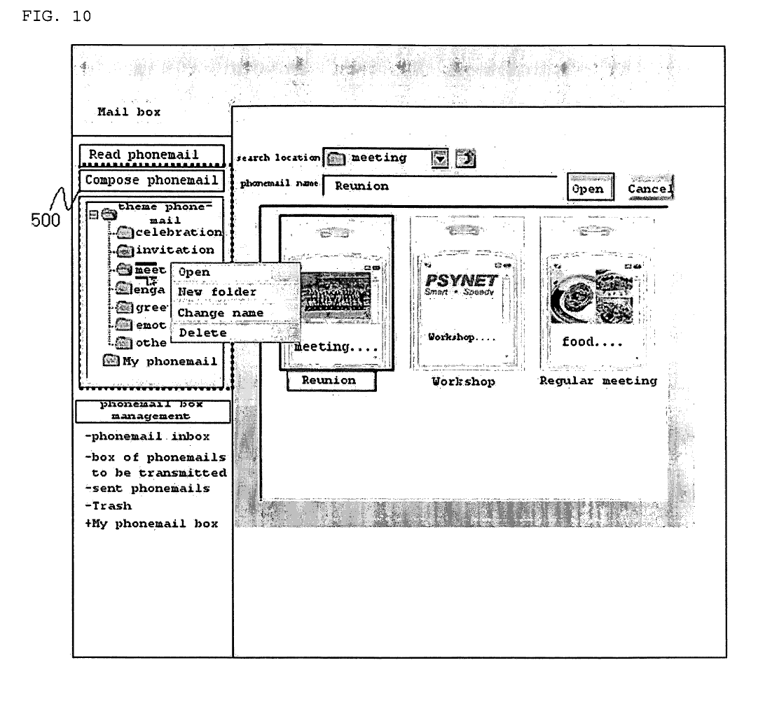

FIG. 2 is a flow chart illustrating a method for providing a phonemail service using wired/wireless communication in accordance with the present invention. FIG. 3 is an exemplary membership registration screen image for allowing a user to register himself or herself as a member in a service provision system in accordance with the present invention. FIG. 4 is an exemplary screen image for inviting a user to edit a phonemail subpage in accordance with the present invention. FIG. 5 is an example for inviting a user to edit a phonemail subpage in accordance with the present invention. FIG. 6 is an exemplary screen image for inviting a user to enter a detailed content of a phonemail subpage in accordance with the present invention. FIG. 7 is an exemplary screen image illustrating the edition of a phonemail subpage in accordance with the present invention. FIG. 8 is an exemplary screen image illustrating the edition of a plurality of link pages included in a phonemail message in accordance with the present invention. FIG. 9 shows exemplary phonemail messages displayed on a called terminal using a phonemail service provision method based on wired/wireless communication in accordance with the present invention. FIG. 10 shows representative phonemail messages in accordance with the present invention.

Firstly, the calling terminal 100 gains access to the service provision system 300 applied to the present invention over the network 150, registers as a member in the service provision system 300, and logs in as a member of the service provision system 300 to construct a phonemail message at step S410.

In more detail, the user of the mobile communication terminal 110 acting as the calling terminal 100 gains access to the mail server 340 included in the service provision system 300 over the network 150, the wired/wireless interface 310, and the WAP server 320. A user of the computer 120 gains access to the mail server 340 included in the service provision system 300 over the network 150, the wired/wireless interface 310, and the Web server 330. The user of the computer 120 enters personal information, for example, ID, name, resident registration number, password, phone number, and E-mail addresses, etc., as shown in FIG. 3, and registers as a member in the service provision system 300. If the user of the computer 120 desires to compose a phonemail message, the user logs in as a member in the service provision system 300 by entering his or her ID and password on the ID/password entry window of FIG. 3.

Thereafter, the user who has logged in as a member in the service provision system 300 can edit a desired phonemail message to be transmitted to the called terminal 200 using the page edition DB 346 included in the service provision system 300 in the form of a plurality of link pages, or can also edit the exemplary phonemail message stored in the basic mail DB 342 included in the service provision system 300 in the form of a user-desired content at step S420.

In other words, in the case where the user of the calling terminal 100 gains access to the service provision system 300, and clicks on a specific menu 500 denoted by “Compose Phonemail” to construct a new phonemail message, a specific screen image shown in FIG. 4 is displayed. The user of the calling terminal 100 can edit and send the new phonemail message on the screen image shown in FIG. 4 using the above-mentioned first method. Otherwise, according to the above-mentioned second method, the user of the calling terminal 100 clicks on one of exemplary phonemail messages (e.g., a reunion phonemail message, a workshop phonemail message, and a regular meeting phonemail message as shown in FIG. 10) included in theme phonemail messages of the Compose Phonemail menu 500, can perform correction of text-, image-, questionnaire-, and bulletin data included in the exemplary phonemail message, and can transmit the corrected data to the called terminal 200.

An edition process based on the above-mentioned first method will hereinafter be described with reference to the annexed drawings.

In this case, the user of the calling terminal 100 drafts a new phonemail message for reunion as shown in FIG. 8. For example, the new phonemail message drafted by the user of the calling terminal 100 includes the reunion chairman greeting subpage, the time/place subpage, the membership fee information subpage, the location information subpage, the questionnaire subpage, the bulletin subpage, and the phone call subpage, as shown in FIG. 8.

If the user of the calling terminal 100 enters a specific term denoted by “Reunion” indicative of name information of the new phonemail message in a current page name entry window 511a included in the Compose Phonemail image of FIG. 4, a phonemail message 511 named a “Reunion” is included in the Menu Configuration field 510.

In more detail, the “Reunion” field 511 is not included in an initial phonemail draft image. If the user of the calling terminal 100 enters a desired phonemail name (e.g., Reunion) in the current page name entry window 511a, the “Reunion” 511 is displayed in the menu configuration field 510.

Thereafter, the user of the calling terminal 100 selects the Reunion item 511 as shown in FIG. 5, clicks on a right button of a mouse (not shown), and clicks on a New Page item included in the New Page popup window 511b. Then, if the user of the calling terminal 100 enters a specific term denoted by “Reunion Chairman Greeting” on a Page Composer menu displayed as a popup window as shown in FIG. 6, a subpage of the Reunion item 511 (e.g., Reunion Chairman Greeting subpage) is constructed in the menu configuration field 510.

The user of the calling terminal 100 edits a plurality of subpages of the Reunion field 511, for example, a reunion chairman greeting subpage, a time/place subpage, a membership fee information subpage, a location information subpage, a questionnaire subpage indicative of attendance or nonattendance, a bulletin subpage indicative of individual opinions, and a phone call subpage shown in FIG. 8, using the page edition DB 346 and the above-mentioned methods shown in FIGS. 4˜7. In this way, in the case where the phonemail message edited in the form of a plurality of link pages is stored in the basic mail DB 342, and the user desires to send the stored phonemail message at a later time, the stored phonemail messge can be used as an exemplary phonemail message.

The user of the calling terminal 100 constructs pages corresponding to the Reunion Chairman Greeting item, the time/place item, and the Membership Fee item using the above-mentioned method, and enters text data indicative of content suitable for characteristics of individual pages in the Mail Draft field 512. In this case, the user of the calling terminal 100 can insert desired image-, picture-, and music data into individual pages using the page edition DB 346 of the service provision system 300. For example, the user can insert desired data into individual pages using the phonemail decoration menu 514 shown in FIG. 7.

A method for editing the location information page shown in FIG. 8 will hereinafter be described. The user of the calling terminal 100 attaches an image file including a map to the Mail Draft field 512, and edits a corresponding page including the image file. The location information DB 343 included in the service provision system 300 invites users of the calling terminal 100 and the called terminal 200 to mutually agree to visually indicate their location information, such the location information of the calling terminal 100 can be visually displayed on the called terminal 200.

A method for editing the questionnaire page shown in FIG. 8 will hereinafter be described. The user of the calling terminal 100 provides a predetermined keyword, e.g., “This reunion is for the 1997 graduating class of the Korea University economics department. Please attend if you are available”. Also, the user of the calling terminal 100 can enter low-level questionnaire content associated with the above-mentioned keyword. Thereafter, if the phonemail message including the above-mentioned questionnaire content is transmitted to the called terminal 200, a user of the called terminal 200 selects the questionnaire subpage shown in FIG. 8, and transmits a response signal indicative of his or her attendance or nonattendance using a phone number of the called terminal 200. As a result, the response results are collected in the questionnaire DB 344 included in the service provision system 300 in real time, and a questionnaire content denoted by a reference image 5a included in the questionnaire subpage is provided to individual members of various clubs or meetings as shown in FIG. 9.

A method for editing the bulletin page shown in FIG. 8 will hereinafter be described. The user of the calling terminal 100 provides a predetermined keyword, and establishes the above-mentioned bulletin item, such that individual reception users can enter bulletin content corresponding to the keyword. Thereafter, if a phonemail message including the above-mentioned bulletin content is transmitted to the called terminal 200, the user of the called terminal 200 can transmit his or her opinion corresponding to the keyword using a phone number of the called terminal 200. Therefore, a transmission result content (i.e. bulletin content transmitted from the user or other members), as shown in the exemplary screen image 6a included in the bulletin page of FIG. 9, can be recognized by the user of the called terminal 200.

A method for editing the phone call page shown in FIG. 9 will hereinafter be described. The user of the calling terminal 100 can establish his or her phone number in the phone call page. Thereafter, in the case where a phonemail message including the above-mentioned phone call page content is transmitted to a reception user, and the reception user selects the phone call page, the reception user can directly communicate with a user of the counterpart terminal (i.e., the called terminal 200) using the mobile communication terminal 110.

A personal user can transmit various information to his or her friends or members using the above-mentioned methods, can collect questionnaire content, or can also collect individual opinions. A user who desires to commercially use the present invention edits contents of the above-mentioned subpages in the form of commercial content, so that the user can commercially use the content of the present invention.

For example, individual companies or shops provide members with list information detailing new products and hot sellers using the bulletin, and can collect questionnaire content associated with their products. Also, members can directly communicate with the above-mentioned companies or shops using the phone call menu, and can perform desired commodity reservation, or can query the companies or shops for the desired commodity.

Although the above-mentioned description has disclosed the first method capable of allowing a user to directly edit subpages of a phonemail message and enter desired phonemail content, the user can also edit exemplary phonemail messages pre-stored by the second method to compose a desired phonemail message.

In more detail, the user or an administrator of the service provision system 300 selects a pre-stored phonemail message from the theme phonemail messages using the above-mentioned method, can select individual pages of the selected phonemail message, and can enter corresponding content in the selected pages.

If the new phonemail message and the exemplary phonemail message are edited by the user of the calling terminal 100 as stated above, then the user of the calling terminal 100 clicks on the Preview menu 520 shown in FIG. 8, and determines whether the edited phonemail message is correctly constructed at step S430.

If it is determined that the phonemail message edited by the user of the calling terminal 100 is incorrectly constructed at step S430, the process returns to step S420. Otherwise, if it is determined that the phonemail message edited by the user of the calling terminal 100 is correctly constructed at step S430, the user of the calling terminal 100 enters phone numbers of users of at least one called terminal 200 in the mail addressee entry field 530 shown in FIG. 8, clicks on a mail transmission button 540, and transmits the resultant phonemail message at step S440.

In the meantime, the above-mentioned description has disclosed the method for constructing/transmitting a phonemail message as shown in steps S410˜S440 in FIG. 2. A method for allowing a user who has received the phonemail message to confirm the phonemail message using the called terminal 200, i.e., step S450, will hereinafter be described.

In this case, the phonemail message transmitted at step S440 may be configured in the form of an E-mail message, an SMS or MMS message, or a callback SMS message, and may be transmitted to the called terminal 200.

As shown in FIG. 9, a user (i.e., a reception user) of the called terminal 200 gains access to the service provision system 300 using a received phonemail message, such that the user can confirm a reunion 511—associated phonemail message including a plurality of link pages 513 at step S450.

In more detail, the user of the called terminal 200 receives a phonemail message associated with the reunion 511 from the calling terminal 100, and is able to confirm individual menus of the link page 513. In this case, the individual menus of the link page 513 are also called subpages, and include the reunion chairman greeting menu, the time/place menu, the membership fee information menu, the location information menu, the questionnaire menu, the bulletin menu, and the phone call menu.

In this case, the user of the called terminal 200 transmits information indicative of attendance or nonattendance to the service provision system 300 using the questionnaire menu, the user of the calling terminal 100 can confirm attendance or nonattendance of individual members. If the user of the called terminal 200 transmits his or her opinion to the service provision system 300 using the bulletin menu, the user of the calling terminal 100 can confirm opinions of individual members.

The user of the called terminal 200 confirms individual menus of the link page 513, and may store or delete a corresponding page according to the importance of individual menus.

As stated above, the user acting as a mail sender can construct and transmit a new phonemail message including a plurality of pages. The other user who has received the above phonemail message views individual pages, and thus more correctly recognizes the mail sender's purpose.

The reunion-associated phonemail message formed by the above-mentioned new phonemail message draft process can be stored in sub-directories of the Theme Phonemail directory or other sub-directories of the My Phonemail directory in the Phonemail Draft menu 500 of FIG. 8 according to the user's intention. In this case, the Theme Phonemail directory and the My Phonemail directory are included in the basic mail DB 343 of the service provision system 300.

In the meantime, if a user acting as a mail sender desires to store a newly-edited phonemail message and transmit the stored phonemail message at a later time, a method for adapting the stored phonemail message as an exemplary phonemail message will hereinafter be described.

The user of the calling terminal 100 can newly construct a variety of subpages associated with the Reunion field 511, i.e., the reunion chairman greeting subpage, the time/place subpage, the membership fee subpage, the location information subpage, the questionnaire subpage, the bulletin subpage, and the phone call subpage, using the above-mentioned first method, can directly transmit a phonemail message including the resultant subpages to the called terminal 200, and can also be stored as an exemplary phonemail message in the basic mail DB 342.

For example, the present invention will hereinafter describe an exemplary phonemail message stored in a predetermined sub-folder “Meeting” of the “Theme Phonmail” folder acting as a main folder of the Compose Phonemail field 500 of FIG. 10.

The user of the calling terminal 100 selects a desired sub-folder (i.e., a “Meeting” sub-folder) from among a plurality of sub-folders (i.e., Celebration-, Invitation-, Meeting-, Engagement-, Greeting-, Emoticon-, and Others sub-folders) contained in the Theme Phonemail folder contained in the Compose Phonemail field 500 provided from the service provision system 300, and confirms pre-stored exemplary phonemail messages, for example, a reunion-associated phonemail message, a workshop-associated phonemail message, and a regular meeting phonemail message.

As shown in FIGS. 4˜8, in the case of exemplary phonemail messages, which are edited by the page edition DB 346 of the service provision system 300 and are then provided to the calling terminal 100 via the basic mail DB 342, if the calling terminal 100 selects a specific exemplary phonemail message corresponding to the Meeting subpage from among the above-mentioned exemplary phonemail messages contained in the Theme Phonemail page acting as one of main pages in the Compose Phonemail menu 500, there arise a reunion subpage, a workshop subpage, and a regular meeting subpage as shown in FIG. 10.

Therefore, the exemplary phonemail message stored in the basic mail DB 342 for use in the service provision system 300 includes new phonemail messages associated with celebration-, invitation-, meeting-, engagement-, greeting-, emoticon-, and others items, or also includes a phonemail message stored by an administrator. In this case, the above-mentioned new phonemail messages have been newly edited by the page edition DB 346, have been transmitted to their addressees, and have been stored.

For example, if individual companies edit a page to be transmitted to their members, they provide the members with a subpage including name card-, discount coupon-, new product-, greeting-, and phone reservation information, such that each company can provide their members with advertisement information associated with new products in real time.

Thereafter, if the user of the calling terminal 100 selects an exemplary phonemail message to be transmitted to the called terminal 200 from among a plurality of exemplary phonemail messages provided from the basic mail DB 342, the service provision system 300 can allow the user of the calling terminal 100 to edit content of the selected exemplary phonemail message.

In more detail, the user of the calling terminal 100 edits a specific menu corresponding to a specific subpage of the Reunion field 511 contained in the Menu Configuration field 510 of FIG. 8 using the page edition DB 346 and the above-mentioned methods shown in FIGS. 4˜7. In this case, provided that the phonemail message edited in the form of a plurality of link pages is stored in the basic mail DB 342, the user of the calling terminal 100 edits the stored phonemail message according to phonemail message content to be transmitted on the condition that the user desires to transmit the stored phonemail message at a later time, and then transmits the edited result to the called terminal.

Although the above-mentioned preferred embodiments of the present invention have been disclosed on the basis of a personal phonemail message, which is constructed by a user and is then transmitted to friends, acquaintances, and members of the user, it should be noted that general enterprises may also provide their customers with commercial phonemail messages for advertisement and marketing purposes.

As apparent from the above description, the present invention provides a method for allowing a calling terminal to construct a phonemail message to be transmitted to a called terminal in the form of a plurality of link pages, such that a large amount of information to be transmitted from the calling terminal can be correctly transmitted to the called terminal.

A user of the calling terminal can easily and quickly construct a phonemail message having a large amount of data using an exemplary phonemail message provided from a service provision system.

Also, the present invention provides a method for allowing users of the calling and called terminals to easily recognize meeting places, participants, and opinions of individual members using a variety of functions, e.g., location information, questionnaire information, and bulletin information.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for providing a phonemail service using wired/wireless communication, comprising the steps of:
a) receiving, by a service provision system, personal information from a user of the calling terminal, registering the user as a member in the service provision system, and receiving log-in information from the user of the calling terminal;
b) constructing, by the service provision system, a new phonemail message including at least one of location, questionnaire, and bulletin menus using a page edition database (DB) upon receiving a request from the calling terminal, or editing content of an exemplary phonemail message to be transmitted from among a plurality of exemplary phonemail messages pre-stored in a basic mail DB;
c) if the new phonemail message is composed or the exemplary phonemail message is edited at step b) such that the calling terminal selects a preview function for the composed or edited phonemail message, determining, by the service provision system, whether the composed or edited phonemail message is correctly constructed;
d) if it is determined that the composed or edited phonemail message is correctly constructed at step c), receiving, by the service provision system, a phone number of a called terminal and an operation signal of a mail transmission button from the user of the calling terminal; and
e) confirming, by a user of the called terminal, a phonemail message transmitted via the service provision system, and receiving, by the service provision system, response signals corresponding to questionnaire and bulletin menus from the called terminal.

2. The method according to claim 1, wherein the location menu at step b) provides the user of the calling terminal and a user of a called terminal with their location information, when the user of the calling terminal attaches a specific image including map information to a desired phonemail message using a location information DB of the service provision system, or the user of the calling terminal and the user of the called terminal mutually agree to visually indicate their location information.

3. The method according to claim 1, wherein the questionnaire menu at step b), if the calling terminal provides a predetermined keyword using a questionnaire DB of the service provision system, and a user of a called terminal transmits a response signal indicative of personal opinion associated with the keyword using a phone number of the called terminal, allows the questionnaire DB of the service provision system to collect the response result of the user of the called terminal in real time, and allows the questionnaire DB to provide the collected response result in real time.

4. The method according to claim 1, wherein the bulletin menu at step b), if the calling terminal provides a predetermined keyword using a bulletin DB of the service provision system, and a user of a called terminal transmits a response signal indicative of personal opinion associated with the keyword using a phone number of the called terminal, allows the bulletin DB of the service provision system to provide transmission content of the response signal in real time.

5. The method according to claim 1, wherein the new phonemail message and the exemplary phonemail message include a plurality of link pages composed of subpages using a page edition DB of the service provision system.

6. The method according to claim 1, wherein individual link pages of the new phonemail message and the exemplary phonemail message include at least one of image, picture, and music data using a page edition DB of the service provision system.

7. The method according to claim 5, wherein individual link pages of the new phonemail message and the exemplary phonemail message include at least one of image, picture, and music data using a page edition DB of the service provision system.

8. The method according to claim 1, wherein the new phonemail message and the exemplary phonemail message provide at least one of location-, greeting-, new product-, discount coupon-, and phone reservation information generated from the calling terminal using a location information DB, a bulletin DB, and a page edition DB of the service provision system.

9. The method according to claim 5, wherein the new phonemail message and the exemplary phonemail message provide at least one of location-, greeting-, new product-, discount coupon-, and phone reservation information generated from the calling terminal using a location information DB, a bulletin DB, and a page edition DB of the service provision system.
